(19) United States
(12) Patent Application Publication
(10) Pub. No.: US 2024/0290939 A1
(43) Pub. Date: Aug. 29, 2024

(54) METHOD OF MANUFACTURING BATTERY

(71) Applicants: Prime Planet Energy & Solutions, Inc., Tokyo (JP); JTEKT CORPORATION, Aichi-ken (JP)

(72) Inventors: Tetsuya SATO, Kobe-shi (JP); Yoshihiko KONDO, Nagoya-shi (JP); Keisuke YOSHIKAWA, Anjo-shi (JP)

(21) Appl. No.: 18/434,814

(22) Filed: Feb. 7, 2024

(30) Foreign Application Priority Data
Feb. 24, 2023 (JP) 2023-027259

(51) Int. Cl. H01M 4/04; H01M 10/04

(52) U.S. Cl. CPC H01M 4/043; H01M 10/0404

(57) ABSTRACT

A method of manufacturing a battery includes the steps of: weighing a plurality of electrode materials to respective predetermined weights and placing the plurality of electrode materials into a container; placing the plurality of electrode materials having been placed in the container into a feeder machine; feeding the plurality of electrode materials from the feeder machine to a twin-screw kneader; and kneading the plurality of electrode materials with the twin-screw kneader.

### CROSS REFERENCE TO RELATED APPLICATIONS

The present application claims priority from Japanese Patent Application No. 2023-027259 filed on Feb. 24, 2023, which is incorporated by reference herein in its entirety.

### BACKGROUND

The present disclosure relates to a method of manufacturing a battery.

JP 2011-233380 A discloses a manufacturing apparatus for manufacturing an electrode mixture slurry for secondary batteries. A weigher is connected to the manufacturing apparatus. The weigher weighs respective materials constituting a powdery battery material so that the mixing ratio of the materials becomes a predetermined mixing ratio, allowing the materials to correspond to a feeding section of the manufacturing apparatus, and feeds the materials into the feeding section of the manufacturing apparatus. It is stated that such a configuration makes it possible to continuously feed the powdery battery material at a predetermined mixing ratio to the feeding unit.

An embodiment disclosed in JP 2011-233380 A employs quantitative feeders as the weigher. In the manufacturing apparatus, materials are fed from two quantitative feeders. An active material is fed from one of the two quantitative feeders, and a conductivity enhancing agent is fed from the other feeder. From the quantitative feeders, predetermined amounts of materials are fed to the continuous manufacturing apparatus. Each of the quantitative feeders is equipped with a material hopper for accommodating materials, a load cell for weighing the materials, a spiral feeder for feeding the materials toward the feeding section of the manufacturing apparatus, and a communication barrel communicating with a powder feeding end of the spiral feeder. The communication barrel is provided upright from the peripheral edge portion of the material receiving port of the manufacturing apparatus. Respective predetermined amounts of the materials are fed out from the spiral feeders of the two quantitative feeders. The materials are supplied via the communication barrel into a casing of the manufacturing apparatus.

### SUMMARY

The present inventors intend to stabilize the product quality of batteries.

According to the present disclosure, a method of manufacturing a battery includes: weighing a plurality of electrode materials to respective predetermined weights and placing the plurality of electrode materials into a container; placing the plurality of electrode materials having been placed in the container into a feeder machine; feeding the plurality of electrode materials from the feeder machine to a multi-screw kneader; and kneading the plurality of electrode materials with the multi-screw kneader.

Such a method of manufacturing a battery makes it possible to obtain stable product quality in manufacturing batteries.

### BRIEF DESCRIPTION OF THE DRAWINGS

FIG. 1 is a flowchart illustrating a method of manufacturing a battery.

FIG. 2 is a schematic view of a slurry manufacturing apparatus 10.

FIG. 3 is a schematic view of a feeder machine 40.

### DETAILED DESCRIPTION

Hereinbelow, embodiments of the technology according to the present disclosure will be described with reference to the drawings. It should be noted, however, that the disclosed embodiments are, of course, not intended to limit the disclosure. The drawings are depicted schematically and do not necessarily accurately depict actual objects. The features and components that exhibit the same effects are designated by the same reference symbols as appropriate, and the description thereof will not be repeated as appropriate.

### Method of Manufacturing Battery

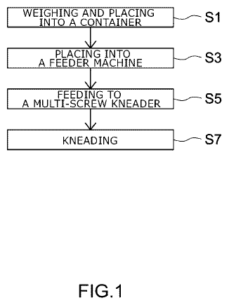

FIG. 1 is a flowchart illustrating a method of manufacturing a battery. As illustrated in FIG. 1, the method of manufacturing a battery includes: step S1 of weighing a plurality of electrode materials to respective predetermined weights and placing the plurality of electrode materials into a container; step S3 of placing the plurality of electrode materials having been placed in the container into a feeder machine; step S5 of feeding the plurality of electrode materials from the feeder machine to a multi-screw kneader; and step S7 of kneading the plurality of electrode materials with the multi-screw kneader. In the following, a method of manufacturing a battery using a slurry manufacturing apparatus 10 will be described as an example of the method of manufacturing a battery.

### Slurry Manufacturing Apparatus 10

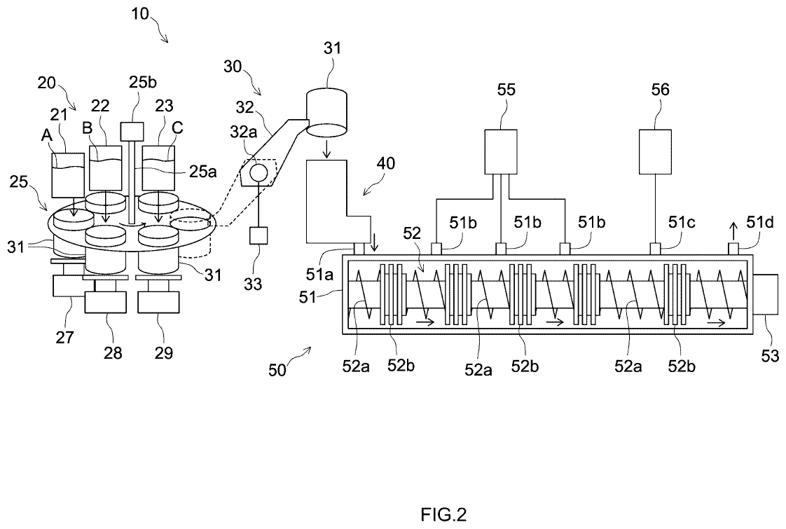

FIG. 2 is a schematic view of the slurry manufacturing apparatus 10. In FIG. 2, the directions in which material is fed or conveyed are indicated by arrows. In the slurry manufacturing apparatus 10, electrode materials and a solvent are kneaded, to manufacture an electrode mixture slurry. In this embodiment, the slurry manufacturing apparatus 10 manufactures a positive electrode mixture slurry containing a positive electrode mixture. As illustrated in FIG. 2, the slurry manufacturing apparatus 10 includes a material feeding device 20, an inverting charger 30, a feeder machine 40, and a twin-screw kneader 50.

First, in the material feeding device 20, a plurality of electrode materials A to C are weighed to respective predetermined weights and placed into a container 31 (S1).

### Material Feeding Device 20

The material feeding device 20 includes feeders 21 to 23 and weighing devices 27 to 29. Powdery electrode materials A to C are fed respectively from the feeders 21 to 23. A known device that is capable of feeding a constant amount of powdery material may be used for each of the feeders 21 to 23. It is possible to use a circle feeder, a screw feeder, a rotary feeder, a belt feeder, or the like for each of the feeders 21 to 23.

The feeders 21 and 23 accommodate the electrode materials A and C, respectively. In this embodiment, each of the electrode materials A and C is a lithium-nickel-cobalt-manganese composite oxide as a positive electrode active material.

Herein, the electrode material A is a lithium-nickel-cobalt-manganese composite oxide having an average particle size of 4μ m and a tap density of 2.2 g/cm³. The electrode material C is a lithium-nickel-cobalt-manganese composite oxide having an average particle size of 17μ m and a tap density of 2.4 g/cm³. The feeder 22 accommodates an electrode material B. In this embodiment, the electrode material B is polyvinylidene difluoride (PVDF) as a binder. Herein, the electrode material B is PVDF having a density of 1 g/cm³.

It should be noted that the positive electrode active materials and the binder are not limited to the just-mentioned examples, but may use various types of materials that are conventionally used as the positive electrode active materials and the binders for lithium-ion secondary batteries without any particular limitation. Examples of the positive electrode active materials may include: particles of an oxide containing lithium and one or more transition metal elements as its constituent metallic elements (i.e., lithium-transition metal oxide), such as lithium nickel oxide (e.g., LiNiO₂), lithium cobalt oxide (e.g., LiCoO₂), lithium manganese oxide (e.g., LiMn₂O₄), and composites thereof (e.g., LiNi_{0.5}Mn_{1.5}O ₄ and LiNi_{1/3}Co_{1/3}Mn_{1/3}O₂); and particles of a phosphate containing lithium and one or more transition metal elements as its constituent metallic elements, such as lithium manganese phosphate (LiMnPO₄) and lithium iron phosphate (LiFePO₄).

Examples of the binder that may be include: acrylic resin, such as (meth) acrylate polymer; halogenated vinyl resin, such as polyvinylidene difluoride (PVDF); and polyalkylene oxide, such as polyethylene oxide (PEO). From the viewpoint of ease in agitating and kneading in the later processing steps, it is possible that the density (or tap density) of the powdery electrode materials that are fed from the feeders may be 0.5 g/cm ³ to 3.0 g/cm³.

The weighing devices 27 to 29 are each a device for weighing the electrode materials A to C that are fed from the feeders 21 to 23. On each of the weighing devices 27 to 29, a container 31 is placed, which holds the electrode materials A to C that are fed respectively from the feeders 21 to 23. The container 31 is arranged on an index table 25. It is possible to arrange a plurality (six in the embodiment shown in FIG. 2) of containers 31 on the index table 25. The index table 25 is rotatively driven in a predetermined direction with predetermined timing by a drive device 25b connected to a shaft 25a. As the index table 25 rotates, the container 31 sequentially moves positions at which the electrode materials A to C are fed from the feeders 21 to 23, from one to another. At that time, the weighing devices 27 to 29 weigh the weights of the electrode materials A to C, respectively, that are fed to the container 31. When one of the containers 31 moves one position at which the electrode materials A to C are to be fed to another, the other containers 31 also move in the same direction and at the same timing. When one of the containers 31 is fed with the materials, the following ones of the containers 31 are also fed with the materials sequentially.

In the weighing devices 27 to 29, the electrode materials A to C are weighed to respective predetermined weights. For each of the weighing devices 27 to 29, it is possible to use, for example, a weighing scale, a load cell, or the like. First, a container 31 moves to a position at which the electrode material A is to be fed. The container 31 is placed on the weighing device 27. The weighing device 27 weighs the weight of the electrode material A that is fed from the feeder 21 to the container 31. Next, the container 31 moves to a position at which the electrode material B is to be fed. The container 31 is placed on the weighing device 28. The weighing device 28 weighs the weight of the electrode material B that is fed from the feeder 22 to the container 31. Next, the container 31 moves to a position at which the electrode material C is to be fed. The container 31 is placed on the weighing device 29. The weighing device 29 weighs the weight of the electrode material C that is fed from the feeder 23 to the container 31.

The weights of the electrode materials A to C that are weighed by the weighing devices 27 to 29 may be set as appropriate according to the target composition of the electrode mixture slurry to be obtained. The weight ratio of the positive electrode active material, the binder, and the conductive agent that are contained in the positive electrode mixture slurry may be, for example, as follows: positive electrode active material:binder:conductive agent=96.0-99.0:0.5-2.0:0.5-2.0, approximately. In this embodiment, the weight ratio of the positive electrode active material, the binder, and the conductive agent that are contained in the positive electrode mixture is set to be: positive electrode active material:binder:conductive agent=97.5:1.0:1.5. The weighing devices 27 to 29 weigh the electrode materials A to C in the container 31 so that their weight ratio is:electrode material A (positive electrode active material):electrode material B (binder):electrode material C (positive electrode active material)=48.75:1.0:48.75. In this embodiment, acetylene black (AB) is used as the conductive agent. The acetylene black as the conductive agent is charged into a later-described twin-screw kneader 50 in the form of paste.

In this embodiment, the electrode materials A to C are placed in the container 31 in the following order: the electrode material A, the electrode material B, and the electrode material C. In the container 31, the electrode material A (positive electrode active material), the electrode material B (binder), and the electrode material C (positive electrode active material) are placed in that order from the bottom toward the opening of the container 31. In the step S1 of weighing the electrode materials and placing the electrode materials into the container 31, after placing the positive electrode active material, which has a relatively higher density, into the container 31, the binder, which has a relatively lower density, is placed into the container 31, and further, the positive electrode active material, which has a relatively higher density, is placed into the container 31.

It should be noted that the method of placing the electrode materials A to C into the inverting charger 30 is not limited to a particular method. For example, it is also possible that the electrode materials A to C may be weighed with another container and thereafter placed into the container 31. In addition, the order in which the electrode materials A to C are placed into the container 31 is not limited to the above-described embodiment. For example, the electrode materials A to C may be placed in the container 31 in the following order: the electrode material C, the electrode material B, and the electrode material A. The order in which materials are put into the container 31 may be set as appropriate depending on the physical properties, number, or the like of the materials.

### Inverting Charger 30

The inverting charger 30 includes an arm 32 and a drive device 33. The arm 32 is configured to be able to hold the container 31. The drive device 33 is a drive device 33 that drives the arm 32 about a fulcrum 32a as the axis that is set in the arm 32. The drive device 33 may be implemented with, for example, a motor, sprockets, and the like.

The electrode materials A to C having been placed in the container 31 are placed into the feeder machine 40 by the inverting charger 30 (S3).

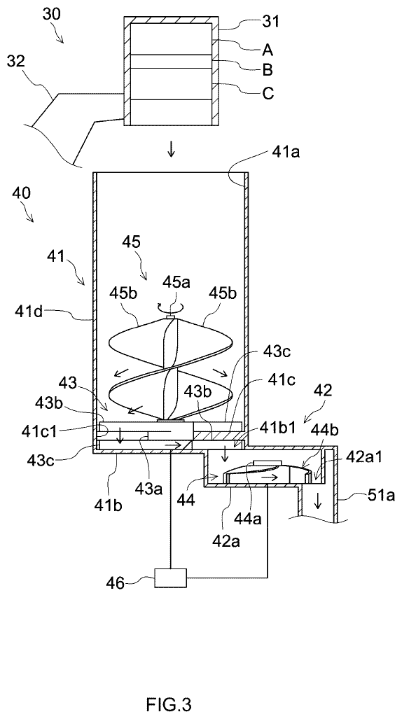

In this embodiment, the drive device 33 causes the arm 32 to rotate toward the feeder machine 40 about the fulcrum 32a as the axis. The drive device 33 causes the arm 32 to stop at a point where the arm 32 is rotated approximately 180 degrees. This allows the opening of the container 31 to be inverted from the state where it faces upward (indicated by dashed lines in FIG. 2) to the state where it faces downward. The position of the inverting charger 30 and the feeder machine 40 is set to be such a position at which the container 31 is inverted over a hopper 41 (see FIG. 3) of the feeder machine 40. An upper part of the hopper 41 is provided with a charge opening 41a through which materials are charged. The electrode materials A to C are dropped from the container 31 that is inverted, and are put into the hopper 41. From the container 31, the electrode materials A to C are charged into the hopper 41 in the following order: the electrode material C, the electrode material B, and the electrode material A. It should be noted that when placing the electrode materials A to C into the feeder machine 40, it is possible to use a device other than the inverting charger 30. For example, it is possible to use an elevating or lowering type inverting charger with which the container is inverted while being elevated or lowered along the elevating or lowering axis.

After the electrode materials A to C are placed into the feeder machine 40, the arm 32 is driven in the opposite direction by the drive device 33. The container 31 is returned to the index table 25. Thereafter, the container 31 moves due to rotation of the index table 25. At this time, another container 31 containing the electrode materials A to C having been weighed is newly transferred to the inverting charger 30. By repeating this process, containers 31 containing the electrode materials A to C are transferred at regular intervals to the inverting charger 30.

The electrode materials A to C are intermittently charged into the feeder machine 40 by the inverting charger 30. The weighing of the electrode materials A to C in the material feeding device 20 and the inversion charging of the electrode materials A to C with the inverting charger 30 may be performed in conjunction with each other. In this embodiment, the charging of the electrode materials A to C into the container 31 in the inverting charger 30 and the inversion charging of the materials from the inverting charger 30 to the feeder machine 40 are repeated at about 30-second cycles. As a result, substantially a constant amount of electrode materials A to C is charged into the feeder machine 40 at substantially regular intervals. In other words, the step S1 of weighing the electrode materials A to C and placing the electrode materials A to C into the container 31 and the step S3 of placing the electrode materials A to C having been placed in the container 31 into the feeder machine 40 are performed repeatedly. The electrode materials A to C with their weight ratio being adjusted can be fed into the feeder machine 40 at predetermined intervals. Because the electrode materials A to C are weighed each time they are charged into the feeder machine 40, the weight ratio of the electrode materials A to C is likely to be stable inside the feeder machine 40. Even when using a plurality of electrode materials A to C, the mixing ratio of the mixed powder materials that are charged into the feeder machine 40 is guaranteed easily.

### Feeder Machine 40

FIG. 3 is a schematic view of the feeder machine 40. In FIG. 3, the directions in which the electrode materials A to C are delivered and the direction in which an agitating member 45 is rotated are indicated by arrows. FIG. 3 shows a cross section of the feeder machine 40 taking along a height direction. This embodiment uses, as the feeder machine 40, a quantitative feeder machine that continuously feeds predetermined quantities of materials (which is hereinafter referred to as a quantitative feeder machine 40). As illustrated in FIG. 3, the quantitative feeder machine 40 includes hoppers 41, 42, impellers 43, 44, an agitating member 45, and a drive device 46. In this embodiment, the quantitative feeder machine 40 is so-called a circle feeder.

The hoppers 41 and 42 are parts that accommodate the electrode materials A to C. In this embodiment, the quantitative feeder machine 40 is provided with two hoppers 41 and 42. The hopper 41 is provided with the impeller 43 and the agitating member 45. The hopper 42 is provided with the impeller 44. The drive device 46 is connected to the impellers 43 and 44.

The hopper 41 is in a substantially cylindrical shape. The charge opening 41athrough which the electrode materials A to C are charged is formed in an upper part of the hopper 41. An opening 41b1 is formed in a portion of a bottom part 41b of the hopper 41. The hopper 41 is connected to the hopper 41 via the opening 41b1. An intermediate plate 41c is provided above the opening 41b1. The intermediate plate 41cis substantially in a disk shape except for an opening 41c1 formed in a portion thereof. The intermediate plate 41c is dimensioned to cover at least the region above the opening 41b1. The opening 41c1 of the intermediate plate 41c and the opening 41b1 of the bottom part 41b are formed at different positions in plan view. The opening 41c1 of the intermediate plate 41c and the opening 41b1 of the bottom part 41b are disposed opposite each other across a shaft 43a of the impeller 43 provided at a substantially central portion of the bottom part 41b.

The impeller 43 includes a shaft 43a and feeding blades 43b and 43c attached to the shaft 43a. The shaft 43a extends upward from the substantially central portion of bottom part 41b. The feeding blades 43b extend radially outward from the shaft 43aalong the upper surface of the intermediate plate 41c. In this embodiment, two feeding blades 43b extend from the shaft 43a. The feeding blades 43c extend radially outward from the shaft 43a along bottom part 41b. In this embodiment, four feeding blades 43cextend from the shaft 43a. The drive device 46 is connected to the shaft 43a. The drive device 46 is, for example, a motor. The drive device 46 may be connected to the shaft 43a via reduction gears, transmission gears, or the like. The drive device 46 rotatively drives the shaft 43a to thereby cause the feeding blades 43b and 43c to rotate.

In this embodiment, the agitating member 45 is provided over the shaft 43a of the impeller 43. Accordingly, the agitating member 45 rotates in association with rotation of the impeller 43. The agitating member 45 includes a shaft 45a and agitating plates 45b. The shaft 45a extends upward from the upper end of the shaft 43a of the impeller 43. Two spiral shaped agitating plates 45b are coiled around the shaft 45a. The two spiral shaped agitating plates 45b are coiled one time around the shaft 45a from the base end toward the tip end of the shaft 45a. Each of the agitating plates 45b is dimensioned to cover the intermediate plate 41c and the bottom part 41b except for their end portions. It should be noted that the agitating member 45 is not limited to such an embodiment, but may be a rod-shaped member or plate-shaped member that is attached to the shaft 45a. The number, angle, and the like of the agitating members 45 are not particularly restricted.

The hopper 42 is in a substantially cylindrical shape with a height lower than the hopper 41. The hopper 42 is provided with the impeller 44. The impeller 44 includes a shaft 44a and feeding blades 44b attached to the shaft 44a. The shaft 44a extends upward from the substantially central portion of a bottom part 42a. The feeding blades 44b curvedly extend radially outward from the shaft 44a along bottom part 42a. The feeding blades 44b with such a shape easily stabilize the amount of the electrode materials A to C to be fed. The height of the feeding blades 44b decreases toward the radially outward ends. In this embodiment, four feeding blades 44b extend from the shaft 44a. It should be noted that the shape, number, and the like of the feeding blades 44b are not limited in any particular way but may be set as appropriate according to, for example, the types of materials. The drive device 46 is connected to the shaft 44a. Accordingly, the impellers 43 and 44 rotate with the same timing. A discharge port 42a1 is formed in the bottom part 42a of the hopper 42. Hereinafter, feeding of the electrode materials A to C into the quantitative feeder machine 40 and discharging of the electrode materials A to C from the quantitative feeder machine 40 will be described.

Because the container 31 is inverted over the hopper 41, the electrode materials A to C that are charged through the charge opening 41a are charged into the quantitative feeder machine 40 in the reverse order in which they were placed into the container 31 (i.e., in the order: the electrode material C, the electrode material B, and the electrode material A in this embodiment). The charged electrode materials A to C are agitated by the agitating member 45 that is rotating. This allows the electrode materials A to C to be dispersed uniformly inside the quantitative feeder machine 40 easily. The electrode materials A to C are delivered toward an outer wall 41d of the hopper 41 in association with the rotation of the agitating member 45. The electrode materials A to C that have reached the intermediate plate 41c are gradually delivered toward the opening 41c1 of the intermediate plate 41c by the feeding blades 43b.

The electrode materials A to C passing through the opening 41c1 of the intermediate plate 41c fall onto the bottom part 41b of the hopper 41. The electrode materials A to C are gradually delivered toward the opening 41b1 of the bottom part 41b by the feeding blades 43c. The electrode materials A to C are delivered through the opening 41b1 to the hopper 42. The electrode materials A to C that have been delivered to the hopper 42 are gradually delivered toward the discharge port 42a1 and then discharged from the quantitative feeder machine 40. The amount of the electrode materials A to C to be discharged from the discharge port 42a1 is set according to the number of rotations the impellers 43 and 44. Because the impellers 43 and 44 are rotatively driven at a constant speed by the drive device 46, a substantially constant amount of the electrode materials A to C can be discharged from the discharge port 42a1. The number of rotations of the impellers 43 and 44 is not limited to a particular number, but may be set as appropriate according to the intervals at which the electrode materials A to C that are inversion charged, the amount thereof, or the like.

As described above, since the impellers 43 and 44 and the agitating member 45 are rotated in the quantitative feeder machine 40, the agitating of the electrode materials A to C inside the hoppers 41 and 42 and the discharging of the electrode materials A to C from the quantitative feeder machine 40 are carried out simultaneously.

The electrode materials A to C are discharged through the discharge port 42a1 of the quantitative feeder machine 40, to be fed to the twin-screw kneader 50 (S5).

### Twin-screw Kneader 50

The twin-screw kneader 50 (see FIG. 2) is a device for kneading the electrode materials A to C while applying a shearing force thereto. The electrode materials A to C are kneaded while they are being conveyed along the conveying direction within the twin-screw kneader 50. As illustrated in FIG. 2, the twin-screw kneader 50 includes a barrel 51, a shaft 52 provided inside the barrel 51, and a drive device 53 for driving the shaft 52. The twin-screw kneader 50 may also be provided with a thermometer for measuring the temperature of the material inside the barrel 51, a chiller for adjusting the material inside the barrel 51, and the like. It should be noted that the device for kneading electrode materials is not limited to the twin-screw kneader, but may be a multi-screw kneader, such as a four-screw kneader.

The barrel 51 is in a cylindrical shape and has space for containing electrode materials, solvent, or the like. At one end of the barrel 51, a powder feed port 51a is formed, through which the electrode materials A to C are fed. The powder feed port 51ais connected to the discharge port 42a1 of the quantitative feeder machine 40. A plurality of solvent feed ports 51b are provided downstream of the powder feed port 51a. A solvent feeding device 55 is connected to the solvent feed ports 51b. A mohno pump may be connected to the solvent feeding device 55 to keep the discharge amount constant. A constant discharge amount of solvent is continuously fed through the solvent feed ports 51b. Examples of the solvent may include water and N-methyl-2-pyrrolidone (NMP). A paste charge port 51c is provided downstream of the plurality of solvent feed ports 51b. A paste feeding device 56 is connected to the paste charge port 51c. Like the solvent feeding device 55, a mohno pump may be connected to the paste feeding device 56, to keep the discharge amount constant. The mohno pump may be provided with a flowmeter for measuring the flow rates of the solvent and paste that are to be fed. In order to stabilize the discharge amount, the rotation of the rotor of the mohno pump may be controlled according to the flow rate obtained by the flowmeter. A constant discharge amount of paste is continuously fed through the paste charge port 51c. In this embodiment, a conductive agent (acetylene black in this embodiment) in a paste form is placed through the paste charge port 51c. In this way, materials for the positive electrode mixture slurry are fed into the barrel 51 in the order: the electrode materials A to C, the solvent, and the conductive agent. A discharge port 51d is provided downstream of the paste charge port 51c. The discharge port 51d is provided at an end of the barrel 51 that is opposite to the powder feed port 51a. A finished positive electrode mixture slurry is discharged from the discharge port 51d.

The shaft 52, which extends along the conveying direction, is provided inside the barrel 51. The shaft 52 is provided with screws 52a and paddles 52b. A plurality of screws 52a and a plurality of paddles 52b are provided along the conveying direction. The screws 52a and the paddles 52b are provided on the outer circumferential surface of the shaft 52. Each of the screws 52a includes a blade that is coiled in a spiral shape.

Each of the paddles 52b is a plate-shaped member including a wider surface facing in the conveying direction. Each of the paddles 52b may be, but is not particularly limited to, a polygonal shape (such as a triangular shape, a quadrangular shape, or a hexagonal shape) in which the corner portions are formed in a curved shape. The side circumferential surface of each paddle 52b may also be formed in a curved shape. A predetermined clearance gap is provided between the side circumferential surfaces of the paddles 52b and the inner circumferential surface of the barrel 51.

The drive device 53 may be, for example, a motor that rotatively drives the shaft 52. As the shaft 52 rotates, the screws 52a and the paddles 52b rotate along the circumferential direction of the shaft 52. The materials in the barrel 51 are pushed by the blades of the screws 52a and conveyed along the conveying direction. A shearing force is applied to the materials in the barrel 51 between the side circumferential surfaces of the paddles 52b and the inner circumferential surface of the barrel 51. The twin-screw kneader 50 may also be provided with a pressure gauge for measuring the pressure inside the barrel 51. The driving by the drive device 53 may be controlled so that the pressure inside the barrel 51 that is measured by the pressure gauge falls within a predetermined pressure range.

The electrode materials A to C are kneaded with the use of the above-described twin-screw kneader 50 (S7).

The electrode materials A to C that have been agitated in the quantitative feeder machine 40 are fed through the powder feed port 51a into the barrel 51 of the twin-screw kneader 50. The inside of the barrel 51 is continuously fed with a substantially constant amount of the electrode materials A to C per unit time by the quantitative feeder machine 40.

The electrode materials A to C are conveyed in the conveying direction by the screws 52a. The electrode materials A to C are conveyed while a shearing force is being applied thereto as they pass through the gap between the side circumferential surfaces of the paddles 52b and the inner circumferential surface of the barrel 51. The electrode materials A to C conveyed in the barrel 51 are mixed with a solvent fed through the solvent feed ports 51b. The solvent is placed into the barrel 51 separately through the plurality of solvent feed ports 51b provided along the conveying direction. This allows the electrode materials A to C and the solvent to be mixed with each other in a step-by-step manner. As a result, it is unlikely to cause unevenness in the materials that are kneaded. The materials conveyed in the barrel 51 (the electrode materials A to C and the solvent herein) are mixed with a conductive agent in a paste form. The conductive agent in a paste form is placed through the paste charge port 51c into the barrel 51. The electrode materials A to C, the solvent, and the conductive agent are conveyed while being kneaded, to thus complete a positive electrode mixture slurry. The manufactured positive electrode mixture slurry is discharged from the discharge port 51d.

With the use of the manufactured positive electrode mixture slurry, a battery may be manufactured. For example, the positive electrode mixture slurry is applied to both sides of a positive electrode current collector and is then dried. The resultant material is cut into a predetermined size and pressure-rolled with a roll press, to prepare a positive electrode sheet in which positive electrode active material layers are provided on both sides of the positive electrode current collector. A negative electrode mixture slurry is also manufactured, and a negative electrode sheet provided with a negative electrode active material is prepared in a similar procedure to the procedure by which the positive electrode sheet was prepared. The positive electrode sheet and the negative electrode sheet are stacked with a separator sheet interposed therebetween, to prepare an electrode assembly. The electrode assembly is accommodated in a battery case, to prepare a battery assembly. An electrolyte solution is filled into the battery assembly, initial charging and an aging process are performed, to thus manufacture a battery.

The present inventors intend to improve uniformity of the materials contained in electrode mixture slurry in order to stabilize the product quality of batteries. In order to stabilize the product quality of batteries, it is necessary to precisely adjust the mixture ratio of the materials contained in the electrode mixture slurry. In addition, according to the knowledge of the present inventors, it is possible to mix the materials while applying a high shearing force to the materials and dilute them with a solvent or the like, by kneading the materials in limited space inside the barrel of a multi-screw kneader. As a result, it is possible to manufacture slurry with high material uniformity. However, it is sometimes the case that the materials contained in an electrode mixture slurry may include materials that are difficult to uniformly disperse in the electrode mixture slurry. Examples of the materials that are difficult to disperse uniformly include binders and thickening agents. In order to cause such materials to uniformly disperse in the electrode mixture slurry, it is necessary to knead the materials while applying a high shearing force to the materials. Nevertheless, when a high shearing force needs to be applied to the materials inside the multi-screw kneader, the load on the shaft may accordingly be high. In cases where the shaft of the multi-screw kneader is long, it is feared that the shaft cannot bear such a high load.

The above-described embodiment includes step S1 of weighing a plurality of electrode materials A to C to respective predetermined weights and placing the plurality of electrode materials A to C into a container 31; step S3 of placing the plurality of electrode materials A to C having been placed in the container 31 into a quantitative feeder machine 40; step S5 of feeding the plurality of electrode materials A to C from the quantitative feeder machine 40 to a twin-screw kneader 50; and step S7 of kneading the plurality of electrode materials A to C with the twin-screw kneader 50. The electrode materials A to C are weighed to respective predetermined weights, placed into the container 31, and subsequently placed into the quantitative feeder machine 40. As a result, the weight ratio of the electrode materials A to C is adjusted precisely in the quantitative feeder machine 40. The twin-screw kneader 50 is continuously fed with a substantially constant amount per unit time of the electrode materials A to C with their weight ratio being adjusted precisely. This allows the twin-screw kneader 50 to knead the electrode materials A to C that are adjusted to have a target mixture ratio easily. As a result, it is likely to obtain a slurry in which the materials are dispersed uniformly, allowing the product quality of the resulting batteries to be stable. In addition, the electrode materials A to C are placed in the container 31 and charged into the twin-screw kneader 50 at one time.

In the above-described embodiment, the electrode materials A to C are fed from the quantitative feeder machine 40 to the powder feed port 51a of the twin-screw kneader 50. In other words, the twin-screw kneader 50 is fed with the electrode materials A to C collectively from one location. This makes it possible to reduce the lengths of the barrel 51 and the shaft 52 of the twin-screw kneader 50 in comparison with, for example, a slurry manufacturing apparatus including a multi-screw kneader to which the electrode materials are fed separately from a plurality of locations. Reducing the length of the shaft 52 serves to reduce the load on the shaft 52 even when a high shearing force is applied to the electrode materials A to C. As a result, it is possible to apply a high shearing force to the electrode materials A to C, and to easily disperse the materials contained in the slurry uniformly.

It is also possible that the step S1 of weighing the electrode materials A to C to respective predetermined weights and placing the electrode materials A to C into the container 31 may include the step of weighing the electrode materials A to C and the step of placing the weighed electrode materials A to C into the container 31.

In the above-described embodiment, the quantitative feeder machine 40 is a circle feeder including impellers 43 and 44 and a drive device 46 rotatively driving the impellers 43 and 44. The use of the circle feeder enables the electrode materials A to C to be fed to the twin-screw kneader 50 continuously. This serves to stabilize the feed amount of the electrode materials A to C. Moreover, the manufacturing facility may be reduced in size in comparison with, for example, the case of using a screw feeder or the like.

In the above-described embodiment, the quantitative feeder machine 40 further includes an agitating member 45. The step S5 of feeding includes agitating the electrode materials A to C placed in the quantitative feeder machine 40. This allows the electrode materials A to C to be mixed preliminarily inside the quantitative feeder machine 40 prior to being kneaded with the twin-screw kneader 50. As a result, the electrode materials A to C contained in the positive electrode mixture slurry can be easily dispersed uniformly. In addition, the agitating member 45 is attached to the impeller 43 of the quantitative feeder machine 40. This means that it is unnecessary to additionally provide a facility for agitating the electrode materials A to C, allowing the size of the manufacturing facility to be smaller.

In the above-described embodiment, the plurality of electrode materials A to C include a first electrode material (PVDF as the electrode material B in this embodiment), and a second electrode material having a higher density than the first electrode material (the positive electrode active material as the electrode materials A and C in this embodiment). The step of weighing and placing the electrode materials into the container 31 includes, after placing a portion of the second electrode material (i.e., the electrode material A) into the container 31, placing the first electrode material (i.e., the electrode material B) into the container 31, and further placing a remainder of the second electrode material (the electrode material C) into the container 31. In the container 31, the electrode material B, which has a relatively lower density, is sandwiched by the electrode materials A and C, which have a relatively higher density. This may reduce flying about of the electrode material B when charging the electrode materials A to C into the container 31 and when charging the electrode materials A to C from the container 31 to the quantitative feeder machine 40. As a result, the weight ratio of the electrode materials A to C that are fed to the twin-screw kneader 50 is allowed to be stable.

Although a method of manufacturing a positive electrode mixture slurry has been described herein as one example, the method according to the disclosure is not limited to such an embodiment. The slurry manufacturing apparatus 10 may also manufacture a negative electrode mixture slurry.

The negative electrode mixture slurry may contain, for example, a negative electrode active material, a thickening agent, and a binder. The materials that may be contained in the negative electrode mixture slurry are not limited to any particular material, but may include various types of materials that are conventionally used as the materials for lithium-ion secondary batteries without any particular limitation. Examples of the negative electrode active material may include: carbon materials represented by artificial graphite, natural graphite, amorphous carbon, and composites thereof (e.g., amorphous carbon coated graphite); materials that form an alloy with lithium, such as silicon (Si); and lithium storage compounds such as a silicon compound (such as SiO). The thickening agent may be, for example, carboxymethylcellulose

(CMC). The binder may be, for example, styrene-butadiene rubber (SBR) or the like.

The weight ratio of the negative electrode active material, the thickening agent, and the binder that may be contained in the negative electrode mixture slurry may be, for example, as follows:negative electrode active material:thickening agent:binder=96.0-99.0:0.5-2.0:0.5-2.0, approximately.

When manufacturing a negative electrode mixture slurry, the negative electrode mixture slurry and CMC may be placed in the container31. SBR as the binder may be charged from the paste charge port 51c, as with acetylene black in a paste form in the case of manufacturing the positive electrode mixture slurry. The steps of manufacturing the negative electrode mixture slurry are similar to the steps of manufacturing the positive electrode mixture slurry, and therefore, the detailed description thereof will not be given further.

Various embodiments of the technology according to the present disclosure have been described hereinabove. Unless specifically stated otherwise, the embodiments described herein do not limit the scope of the present disclosure. It should be noted that various other modifications and alterations may be possible in the embodiments of the technology disclosed herein. In addition, the features, structures, or steps described herein may be omitted as appropriate, or may be combined in any suitable combinations, unless specifically stated otherwise.

In addition, the present description includes the disclosure as set forth in the following items.

Item 1:

A method of manufacturing a battery, including the steps of:
weighing a plurality of electrode materials to respective predetermined weights and placing the plurality of electrode materials into a container;
placing the plurality of electrode materials having been placed in the container into a feeder machine;
feeding the plurality of electrode materials from the feeder machine to a multi-screw kneader; and
kneading the plurality of electrode materials with the multi-screw kneader.

Item 2:

The method according item 1, wherein the feeder machine includes a circle feeder including an impeller and a drive device rotatively driving the impeller.

Item 3:

The method according to item 2, wherein:
the feeder machine further includes an agitating member; and
the step of feeding includes agitating the plurality of materials placed in the feeder machine.

Item 4:

The method according to item 3, wherein the agitating member is attached to the impeller of the feeder machine.

Item 5:

The method according to any one of items 1 to 4, wherein:
the plurality of electrode materials include a first electrode material and a second electrode material having a higher density than the first electrode material; and
the step of weighing and placing the plurality of electrode materials includes, after placing a portion of the second electrode material into the container, placing the first electrode material into the container, and further placing a remainder of the second electrode material into the container.

What is claimed is:

1. A method of manufacturing a battery, comprising the steps of:
weighing a plurality of electrode materials to respective predetermined weights and placing the plurality of electrode materials into a container;
placing the plurality of electrode materials having been placed in the container into a feeder machine;
feeding the plurality of electrode materials from the feeder machine to a multi-screw kneader; and
kneading the plurality of electrode materials with the multi-screw kneader.

2. The method according to claim 1, wherein the feeder machine comprises a circle feeder including an impeller and a drive device rotatively driving the impeller.

3. The method according to claim 2, wherein:
the feeder machine further includes an agitating member; and
the step of feeding includes agitating the plurality of materials placed in the feeder machine.

4. The method according to claim 3, wherein the agitating member is attached to the impeller of the feeder machine.

5. The method according to claim 1, wherein:
the plurality of electrode materials include a first electrode material and a second electrode material having a higher density than the first electrode material; and
the step of weighing and placing the plurality of electrode materials includes, after placing a portion of the second electrode material into the container, placing the first electrode material into the container, and further placing a remainder of the second electrode material into the container.
